(19) United States
(12) Patent Application Publication
(10) Pub. No.: US 2007/0057926 A1
(43) Pub. Date: Mar. 15, 2007

(54) Touch panel input device

(75) Inventors: Yoshiki Ohzawa, Chita-gun (JP); Tomoaki Mizuno, Toyoake-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/519,012

(22) Filed: Sep. 12, 2006

(30) Foreign Application Priority Data
Sep. 12, 2005 (JP) 2005-264279

(51) Int. Cl. G09G 5/00

(52) U.S. Cl. 345/173

(57) ABSTRACT

In a screen on a touch panel of a navigation device, an operation key is displayed in a standard size until a press operation is detected. When a press operation is detected and a press area is determined to be larger than a standard area corresponding to the standard size of the operation key, the size of the operation key is changed to be larger than the standard size.

### CROSS REFERENCE TO RELATED APPLICATION

This application is based on and incorporates herein by reference Japanese Patent Application No. 2005-264279 filed on Sep. 12, 2005.

### FIELD OF THE INVENTION

The present invention relates to a touch panel input device.

### BACKGROUND OF THE INVENTION

In a touch panel input device in Patent document 1, the number of divisions in a touch panel varies based on sizes of operation keys displayed in the screen or interval distances between the operation keys.

Patent document 1: JP-2002-323957 A

As explained in Patent document 1, if the operation keys displayed in the screen are not allowed to change their sizes, a user may feel inconvenient in touching the operation keys. Therefore, it is favorable that sizes of operation keys be changeable.

In navigations devices, operation keys are superimposed on a road map or a background display image in the screen. If enlarged operation keys are initially displayed for a user having a large finger, the enlarged operation keys decrease or interfere with a road map displayed rearward of the operation keys, which prevents the road map from being sufficiently shown to the user.

### SUMMARY OF THE INVENTION

It is an object of the present invention to provide a touch panel input device. An operation key of the touch panel input device can be changeable in its size in a screen while helping prevent a display area of a display image, on which the operation key is superimposed, from getting excessively small.

According to an aspect of the present invention, a touch panel input device is provided as follows. A touch panel is disposed frontward of a screen. Display control means displays in the screen an operation key for performing an input to a device. Press detecting means detects in the touch panel a press position and, furthermore, a press area. Device control means controls an operation of the device based on the detected press position. Key size change means changes a size of the operation key displayed in the screen based on the detected press area.

According to another aspect of the present invention, a method, which is used in a touch panel input device having a touch panel frontward of a screen, is provided with the following: displaying an operation key in the screen for performing an input to a device; detecting in the touch panel a press position and, furthermore, a press area; controlling an operation of the device based on the detected press position; and changing a size of the operation key displayed in the screen based on the detected press area.

### BRIEF DESCRIPTION OF THE DRAWINGS

The above and other objects, features, and advantages of the present invention will become more apparent from the following detailed description made with reference to the accompanying drawings. In the drawings:

FIG. 1 is an overall configuration of a navigation device as an example of an embodiment according to the present invention;

FIG. 2 is a view of a display example of standard sizes of operation keys;

FIG. 3 is a view of a display example of sizes of operation keys larger than the standard sizes; and

FIG. 4 is a flowchart diagram of an operation of the navigation device.

### DETAILED DESCRIPTION OF THE PREFERRED EMBODIMENTS

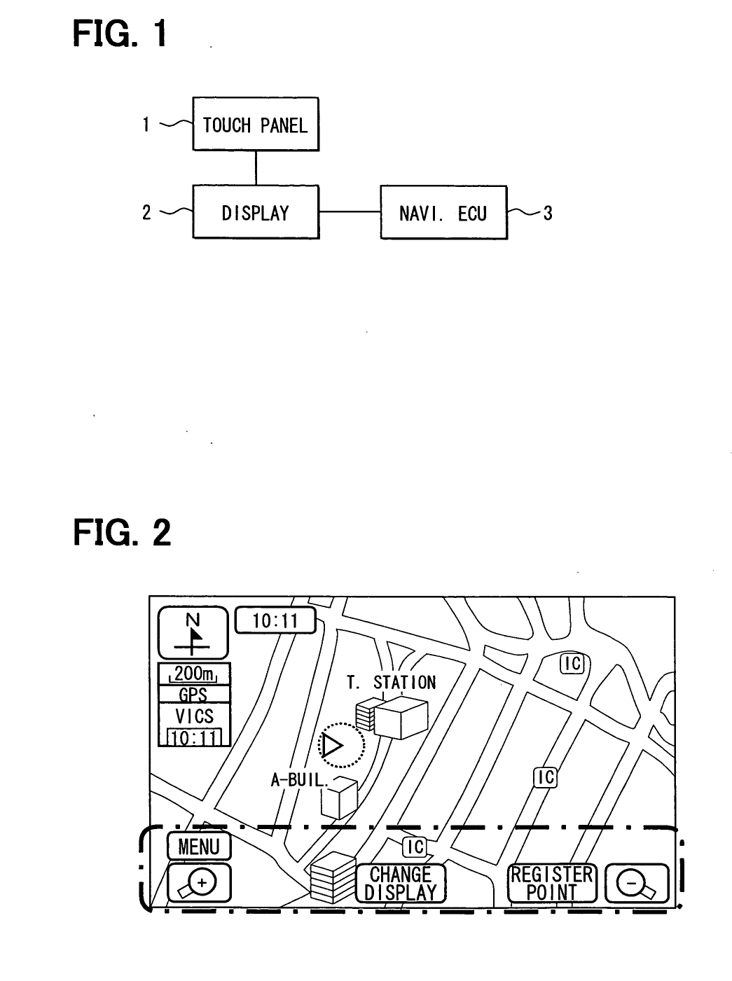

A touch panel input device as an example of an embodiment according to the present invention will be explained with reference to FIGS. 1 to 4. In this example, the touch panel input device is used for an input to a navigation device; however, it can be used for an input to various devices other than the navigation device.

FIG. 1 shows an overall configuration of the navigation device provided in a vehicle. The navigation device includes a touch panel 1, a display device 2, and a navigation ECU 3. The touch panel 1 is arranged on a screen in the display device 2. A display image including a road map and characters on the screen is visible via the touch panel 1 to a user. For example, the touch panel 1 has a two-layer structure (similar to that of the touch panel described in Patent document 1) of an upper-layer resistance film and a lower-layer resistance film. A voltage is applied from a device (not shown) to the upper-layer resistance film in an X direction (laterally) and the lower-layer resistance film in a Y direction (longitudinally), alternately.

Suppose the case that a user presses a certain position (hereinafter, press position) on the touch panel 1. In this case, when a voltage is applied to the upper-layer resistance film, the applied voltage is divided in the X direction based on resistance corresponding to the press position and a voltage signal Vxout thereby outputs from the lower-layer resistance film. In contrast, when a voltage is applied to the lower-layer resistance film, the applied voltage is divided in the Y direction based on resistance corresponding to the press position and a voltage signal Vyout thereby outputs from the upper-layer resistance film.

These outputted voltage signals Vxout and Vyout, which correspond to press positions in the X direction and Y direction, respectively, are then analog-digital converted into the X-Y coordinates of the press position.

Further, the touch panel 1 is designed such that its entire area is divided into a given number of divisions (or a given division count) and a voltage applied to the touch panel 1 can be outputted to correspond to each division. These outputted voltage signals Vxout and Vyout can indicate a press area on the touch panel 1 (e.g., how many divisions correspond to the press area).

The display device 2 includes a liquid crystal display and is disposed at a position, e.g., instrument panel, which a driver easily sees. The screen in the display device 2 displays a road map (as a display image) and operation keys (within an area surrounded by dashed lines) to perform an input operation for the navigation device. A user touches each of the operations keys to control a corresponding operation of the navigation device.

The navigation ECU 3 is a known computer to include a CPU, ROM, RAM, I/O, and bus line connecting the foregoing components. The ECU 3 detects a press position and press area from voltage signals Vxout and Vyout from the touch panel 1 via the display device 2. The ECU 3 controls each of various functions of the navigation device based on an operation key corresponding to the detected press position. The various functions include a road map scale change function, a menu display selection function, a destination setting function, a route retrieval function, a route guidance start function, a current position correction function, a display window changing function, and a sound volume control function.

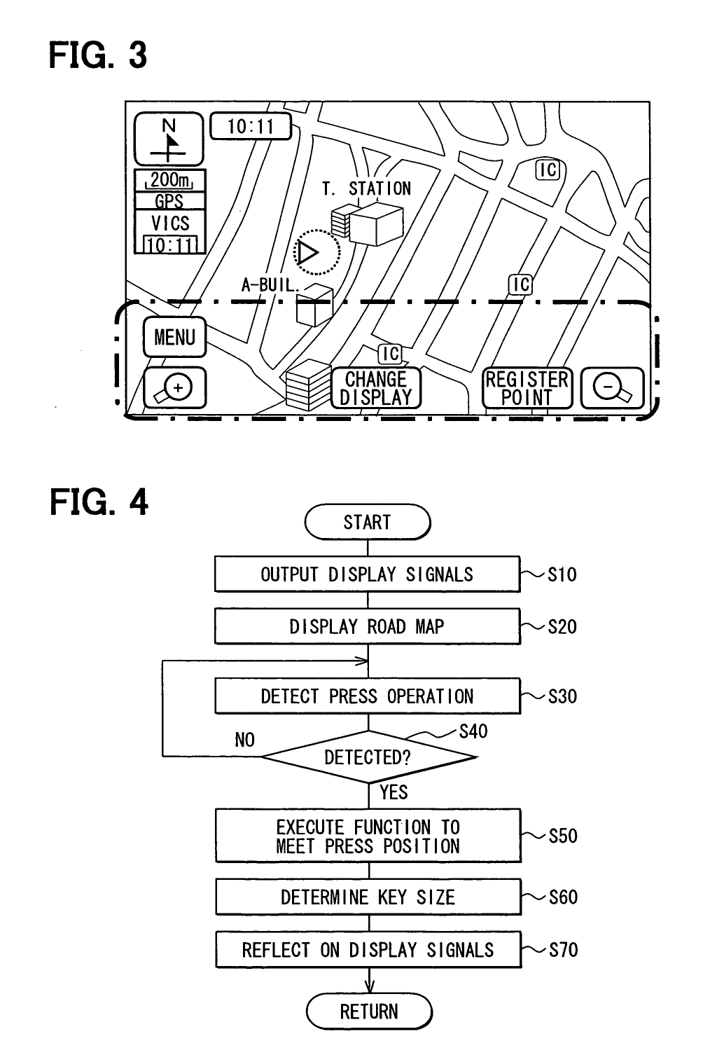

Features of the navigation device will be explained below. The navigation device changes sizes of operation keys based on a press area detected along with a press position on the touch panel 1. For instance, the sizes of the operation keys are maintained in their standard sizes (e.g., the sizes of the operation keys shown in FIG. 2) until a press operation is detected on the touch panel 1. When a press operation is detected and a press area is determined to be larger than a standard press area corresponding to a standard size of an operation key, the size of the operation key is enlarged as shown in FIG. 3 from the standard size in FIG. 2.

Thus, an operation key is initially displayed in a standard size and then enlarged from the standard size only when a press area is detected to be larger than the standard press area (i.e., when a finger of a user is larger than a standard size of a finger). This eliminates necessity to enlarge sizes of operation keys at an initial stage. This helps prevent an area for a display image or characters shown rearward of the operation keys from being unnecessarily decreased; the sizes of the operation keys can be changed at a later stage as needed.

Next, an operation of the navigation device will be explained with reference to a flowchart in FIG. 4. At Step S10, the ECU 3 generates display signals for displaying images to output to the display device 2. At Step S20, the display device 2 receives the display signals to display in the screen. This allows a road map or the like to be shown in the screen, as shown in FIG. 2.

At Step S30, a detection of a press operation on the touch panel 1 is started. At Step S40, it is determined whether a press operation is detected or not, i.e., whether voltage signals Vxout and Vyout are detected or not. When the determination at Step S40 is affirmed, the sequence proceeds to Step S50; when negated, to Step S30, where a detection of a press operation is continued.

At Step S50, the navigation device executes a function corresponding to a press position detected. At Step S60, a press area (e.g., how many divisions the press area covers) is detected based on the outputted voltage signals Vxout and Vyout. When the detected press area is determined to be larger than a standard press area corresponding to a standard size of an operation key, the size of the operation key is determined to be changed to be larger than the standard size. Here, as shown in FIG. 3, the operation keys in the screen are simultaneously enlarged. In contrast, when the detected press area is determined to be smaller than or approximately equal to the standard size, the sizes of the operation keys are determined to maintained as same as their standard sizes. At Step S70, the sizes of the operation keys determined at Step S60 are reflected on the display signals generated at Step S10. Then the sequence is repeated from Step S10.

(Modification)

For instance, assume that the sizes of the operation keys are enlarged without changing the number of divisions (or division count). A press operation may cause a division corresponding to an adjacent operation key to be mistakenly detected although a user does not intend to press the adjacent operation key.

Therefore, the number of divisions may be changed based on the sizes of the operation keys determined at Step S60 in FIG. 4. For instance, when the sizes of the operation keys are changed to be larger than the standard sizes, the number of divisions may be decreased. Thus, the larger the sizes of the operation keys become, the smaller the number of divisions becomes. This allows the press position on the touch panel 1 to be accurately detected.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. A touch panel input device, comprising:
a touch panel disposed frontward of a screen;
display control means for displaying in the screen an operation key for performing an input to a device;
press detecting means for detecting in the touch panel a press position and, furthermore, a press area;
device control means for controlling an operation of the device based on the detected press position; and
key size change means for changing a size of the operation key displayed in the screen based on the detected press area.

2. The touch panel input device of claim 1, wherein
the display control means displays the operation key in a standard size until the press detecting means detects a press position, and
the key size change means changes the size of the operation key to become larger than the standard size when the detected press area is larger than a standard area corresponding to the standard size of the operation key.

3. The touch panel input device of claim 1, further comprising:
division count change means for changing a division count used for dividing an area of the touch panel, based on the size of the operation key.

4. The touch panel input device of claim 3, wherein
the division count change means decreases the division count as the size of the operation key becomes larger.

5. The touch panel input device of claim 1, wherein
the display control means displays an operation key for performing an input to a navigation device, and
the device control means controls an operation of the navigation device.

6. A method used in a touch panel input device having a touch panel frontward of a screen, comprising:
displaying an operation key in the screen for performing an input to a device;
detecting in the touch panel a press position and, furthermore, a press area;
controlling an operation of the device based on the detected press position; and
changing a size of the operation key displayed in the screen based on the detected press area.

7. A touch panel input device, comprising:
a touch panel disposed frontward of a screen;
a press detecting unit that detects in the touch panel a press position and, furthermore, a press area;
a display control unit that displays in the screen an operation key for performing an input to a device;
a device control unit that controls an operation of the device based on the detected press position; and
a key size change unit that changes a size of the operation key displayed in the screen based on the detected press area.
